(19) United States
(12) Patent Application Publication
(10) Pub. No.: US 2006/0253271 A1
(43) Pub. Date: Nov. 9, 2006

(54) Method for facilitating transformation of multi-threaded process-oriented object code to event-based object code

(75) Inventors: Mark Davis, Austin, TX (US); Trevor Robinson, Austin, TX (US); Jon Nall, Austin, TX (US)

Correspondence Address: Raymond M. Galasso;Galasso & Associates, LP, P.O. Box 26503, Austin, TX, 78755-0503, US

(73) Assignee: Newisys, Inc.

(21) Appl. No.: 11/114,568

(22) Filed: Apr. 26, 2005

(51) Int. Cl. G06F 17/50

(52) U.S. Cl. 703/15

(57) ABSTRACT

A method comprises analyzing multi-threaded process-oriented object code representing a simulation model and transforming said multi-threaded process-oriented object code to event-based object code representing a simulation model equivalent to simulation model represented by said multi-threaded process-oriented object code. Transformation is performed automatically in response to the analysis and includes creating continuation functionality between adjacent threads of execution. Analyzing object code includes determining a potentially blocking method and analyzing its control flow. Transforming multi-threaded process-oriented object code includes configuring the event-based object code to schedule a jump to a first one of a plurality of non-blocking Runnable methods of the simulation model represented by the event-based object code. Analyzing control flow of the potentially blocking method includes segmenting the potentially blocking method into the plurality of non-blocking Runnable methods and associating each one of the non-blocking Runnable methods with a respective one of a plurality of available exception handlers.

### FIELD OF THE DISCLOSURE

The disclosures made herein relate generally to simulation techniques for object code and, more particularly, to transformations of thread-based object code to event-based object code.

### BACKGROUND

Hardware simulations, such as those for application specific integrated circuits (ASIC), require an expression of high degrees of parallelism to match the parallelism found by the underlying hardware. ASIC simulations typically use several hundred threads. Threads are “light weight processes” (LWPs), which typically reduce overhead by sharing fundamental parts to allow switching to be facilitated more frequently and efficiently. There are application domains that routinely deal with thousands or tens of thousands of threads.

When using threads to simulate equivalent concepts in hardware, often the threads express very lightweight concepts. An example is a clock. In this case, a thread gets scheduled, toggles a bit representing the clock, and suspends itself waiting on the scheduling of the next clock transition. The overhead in the thread scheduling, context switches, queuing for another event, and suspension often swamp the effective processing by orders of magnitude.

Typical simulation structural approaches include event-based simulations (i.e., simulations represented by event-based object code) and process-oriented simulations (i.e., simulations represented by process-oriented object code). Event-based simulations are relatively fast, require programmers to carefully divide each sequence of operations into non-blocking handlers that maintain persistent state, and include call-back handlers that are registered to respond to various events (e.g., code to handle a blocking call first initiates an asynchronous request, and then registers a call-back method to complete the computation when the request has completed). Thus, event-based simulations tend to be more efficient and higher performance than process-oriented simulations that are subjected to multiple types of thread overhead (context switch, blocking, critical regions, etc.).

On the other hand, process-oriented simulations allow a programmer to write a logically sequential program but have relatively high context switching overhead. Thus, as compared to event-based simulation, process-oriented simulations can be developed in a manner that is more intuitive, is better match a particular domain object model, and is easier to develop and maintain. Accordingly, from a conceptual standpoint, developers would generally have a preference for developing process-oriented simulations while gaining the execution efficiency of event-based simulations.

Java Bytecode is an example of a specific type of object code. It is the equivalent of assembly code for a Java Virtual Machine (JVM), which is a stack-based machine. Upon invocation, each method within Java Bytecode has a set of-local variables and an operation stack. Java Bytecode instructions provide functionality such as, for example, loading/storing to a set of local variables, facilitating execution of invocation instructions (calling methods), serving as arithmetic operators and providing for flow control operators (e.g., comparison, goto, jsr, return).

Java has “built-in” threads, which are useful in the Java simulation environment. However, considerable thread overhead in the Java simulation environment is a primary cause of poor simulation performance. For example, one contributor to such considerable thread overhead is that current Linux JVMs (Java Virtual Machines) map Java threads 1:1 to Linux kernel threads. This approach to converting Java Bytecode into machine language adversely impacts thread overhead. Furthermore, conventional JVMs only support native threads. Supporting only native threads is undesirable for certain applications. For example, conventional JVMs are generally undesirable in applications where relatively low thread switching overhead is required, true concurrency is not required, manipulation of JVM code is unacceptable and reliance on experimental JVMs is unacceptable.

Conventional approaches for overcoming the overhead problems associated with converting a multi-threaded process-oriented simulation model (e.g., a Java multi-threaded process-oriented simulation model) to a corresponding event-based simulation model (e.g., a Java event-based simulation model) are, at best, limited in their effectiveness and/or workability. One conventional approach for overcoming such overhead problems is a kernel thread library that offers increased efficiency.

A relatively newly-issued POSIX (Portable Operating System Interface for Unix) Thread Library (NPTL) is an example of a conventional JVM threading solution that is intended to offer enhanced threading efficiency. This new POSIX Thread Library is considered to be considerably more efficient than the current Linux kernel thread library. However, the NPTL is presently only available on latest non-production kernels and still lacks sufficient performance for dealing with a large number of lightweight threads found in a simulation environment.

Continuations provide an underlying framework suitable for facilitating thread-to-event based transformations. However, prior efforts relating to implementation of continuations for such utilization has been largely incomplete with respect to enablement, reduction to practice and/or effectiveness. In one example of such prior efforts, a paper by Begel et al of the University of California at Berkley (i.e., the Begel paper) proposed a lightweight thread model, which the authors referred to as PicoThreads. The Begel paper was academic in nature and provided no implementation of the concepts discussed therein. In another example of such prior efforts, a web application framework, referred to as RIFE, implements special cases of some of the PicoThreads concepts discussed by Begel et al in a manner that allows them to handle more concurrent I/O transactions in their web application. However, RIFE offers only limited transformation functionality (i.e., for such special cases of the PicoThread concepts). In still another example of such prior efforts, a paper by Andreas Martens from the Department of Computing at the Imperial College of London (i.e., the Martens paper) discusses implementation of continuations for facilitating thread-to-event based transformations. This paper did not discuss specific details for implementing of continuations for such utilization and did not tackle key required issues relating to implementation such as, for example, handling exceptions, dealing with method return values and dealing with access privileges.

Therefore, an approach for facilitating process-oriented object code-to-event-based object code transformations in a manner that overcomes drawbacks associated with conventional approaches for such transformations would be useful, advantageous and novel.

### SUMMARY OF THE DISCLOSURE

Embodiments of the present invention provide for improved efficiency of simulation models. More specifically, embodiments of the present invention provide for automatic translation of multi-threaded process-oriented object code to event-based object code through leveraging of continuations. For example, performing analysis of Java multi-threaded process-oriented object code for a simulation and transforming it to event-based object code representing an equivalent simulation serves to improve simulation performance (e.g., accelerate simulation execution). Because there are a considerable number of lightweight threads in hardware verification simulations, avoiding overhead associated with thread context switches is vital to improving efficiency of simulation models. To this end, transformation from multi-threaded process-oriented object code to event-based object code in accordance with the present invention dramatically reduces multi-threading overhead by transformation to events

The present invention provides for dramatic simulation acceleration with no intervention from the developer. Because the present invention eliminates multi-threading overhead by transformation to events, it allows the developer to more naturally express all the parallelism that exists in the application logically as threads, and have the transformation automatically eliminate the implicit overhead. This allows the developer to express their simulation using hundreds or thousands of threads, mapping conceptually to the underlying logical model of the domain being simulated. In practice, the developer is able to write programs in a process-based fashion (i.e., in accordance with multi-threaded process-oriented simulation), but gain the benefits of event-based execution (i.e., in accordance with event-based simulation).

The result of such transformations is that a developer (e.g., developing hardware simulations using object code) is provided with the benefits associated with both process-oriented object code and event-based object code. For example, simulations in accordance with event-based object code tend to be more efficient and higher performance than simulations in accordance with process-oriented object code that are subjected to multiple types of thread overhead (context switch, blocking, critical regions, etc.). On the other hand, as compared to simulations in accordance with event-based object code, simulations in accordance with process-oriented object code can be developed in a manner that is more intuitive, is better match a particular domain object model, and is easier to develop and maintain.

In one embodiment of the present invention, a method for transforming multi-threaded process-oriented object code to event-based object code comprises analyzing multi-threaded process-oriented object code and transforming the multi-threaded process-oriented object code to event-based object code equivalent to the multi-threaded process-oriented simulation model. Transforming is performed automatically in response to the analyzing and includes creating continuation functionality between adjacent Runnable blocks of the event-based object code.

In another embodiment of the present invention, a method for transforming a simulation model represented by multi-threaded process-oriented object code to an equivalent simulation model represented by event-based object code comprises determining a potentially blocking method in multi-threaded process-oriented object code representing a simulation model, segmenting the potentially blocking method into a plurality of non-blocking Runnable methods and configuring event-based object code representing a simulation model equivalent to the simulation model represented by the multi-threaded process-oriented object code. The event-based object code is configured to schedule a jump to a first one of a plurality of non-blocking Runnable methods of the event-based object code.

In another embodiment of the present invention, a method for transforming a simulation model represented by multi-threaded process-oriented Java Bytecode to an equivalent simulation model represented by event-based Java Bytecode comprises analyzing multi-threaded process-oriented Java Bytecode representing a simulation model and transforming the multi-threaded process-oriented Java Bytecode representing the simulation model to event-based Java Bytecode representing a simulation model equivalent to the simulation model represented by the multi-threaded process-oriented Java Bytecode. Transforming is performed automatically in response to the analyzing and includes creating continuation functionality between adjacent threads of execution.

Turning now to specific aspects of the present invention, in at least one embodiment, analyzing object code includes determining a potentially blocking method and analyzing control flow of the potentially blocking method and transforming multi-threaded process-oriented object code representing the simulation model includes configuring the event-based object code representing the simulation model to schedule a jump to a first one of a plurality of non-blocking Runnable methods of the simulation model represented by the event-based object code.

In at least one embodiment of the present invention, analyzing control flow of the potentially blocking method includes segmenting the potentially blocking method into the plurality of non-blocking Runnable methods and associating each one of the non-blocking Runnable methods with a respective one of a plurality of available exception handlers.

In at least one embodiment of the present invention, continuation functionality includes providing direction to a next instruction that a thread follows during a subsequent instance of execution and providing context information accessible by the thread during the subsequent instance of execution.

In at least one embodiment of the present invention, transformation functionality includes means for at least one of handling exceptions, dealing with access privileges, and dealing with method return values and handling abstract methods.

These and other objects and embodiments of the inventive disclosures made herein will become readily apparent upon further review of the following specification and associated drawings.

### BRIEF DESCRIPTION OF THE DRAWING FIGURES

FIG. 1 depicts an embodiment of a method for transforming multi-threaded process-oriented object code to equivalent event-based object code in accordance with the present invention.

FIG. 2 depicts an embodiment of an object code process flow in accordance with the present invention.

### DETAILED DESCRIPTION OF THE DRAWING FIGURES

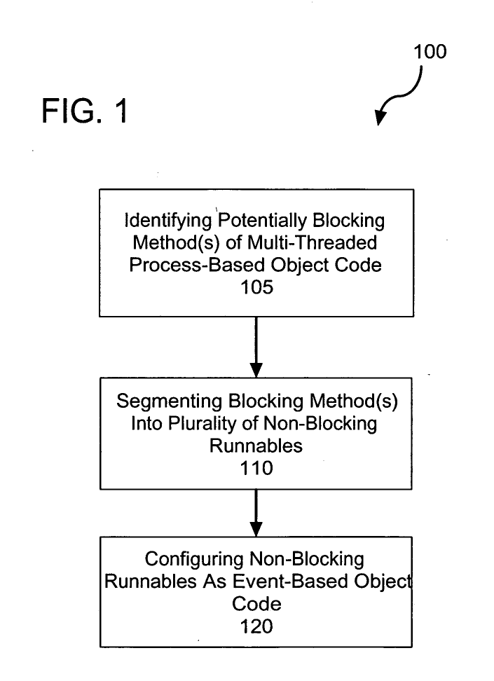

FIG. 1 depicts an embodiment of a method for transforming multi-threaded process-oriented object code to equivalent event-based object code (generally referred to as the method 100) in accordance with the present invention. Broadly, the method depicts an embodiment of transformation functionality in accordance with the present invention. The underlying novelty and usefulness of transformation functionality in accordance with the present invention is largely independent of the source form. Java Bytecode is one example of object code capable of being transformed using the method 100. Transforming multi-threaded process-oriented object code representing a hardware simulation (e.g., an ASIC simulation) to event-based object code representing an equivalent hardware simulation is one example of an application for the method 100. Accordingly, transformation functionality in accordance with the present invention may also be applied to transformation of source code and/or traditional compiled object code. It is disclosed herein that a skilled person will appreciate other types of object code and applications for which the method 100 and transformation functionality in accordance with the present invention provides advantageous and/or useful utility.

The method 100 includes an operation 105 for identifying one or more potentially blocking methods of multi-threaded process-oriented object code. Potentially blocking methods include those that actually would block and those would not block but appear to be blocking. A blocking method (e.g., executing in a blocking thread) yields control to another method (i.e., executing in another thread). A method blocks if any of the following conditions exist: a.) the method invokes a call asking to yield control of this thread, b.) the method invokes a call asking to wait on some event or c.) the method invokes a method for which either (a) or (b) holds true. For example, if method X calls method Y and method Y calls method Z, which yields, then method X, method Y, and method Z are all blocking methods.

A blocking method generally blocks while waiting for some event to occur. The blocking method is rescheduled for execution at a later time after the event it is blocking on has occurred. By analyzing methods of the multi-threaded process-oriented object code, potentially blocking methods and their associated blocking points are identified, thus providing the information required for allowing execution of the blocking method to resume appropriately when transformed to event-based object code.

Abstract methods, which include virtual methods and interface methods, are also examples of blocking methods. With abstract methods, there is the potential for not knowing which implementation will be called until runtime. Through transformation functionality in accordance with the present invention, each abstract method implementation referenced in the scope of the blocking analysis is analysed. If any of the implementations of a given abstract method block, then that abstract method is treated as a blocking method.

Upon determining one or more blocking methods, an operation 110 is performed for segmenting the one or more blocking methods into a respective plurality of non-blocking Runnables. In one embodiment, the operation 110 preferably performs analysis of blocks of contiguous instructions (e.g., Java Bytecode instructions) that do not contain instructions that branch (i.e., jump to an instruction other than the next instruction) or block (i.e., yield control to another thread). Such blocks are referred to as basic blocks and such an analysis is generally referred to as a basic block analysis.

Basic blocks are further categorized into sets of basic blocks called Runnables. During the operation 110 for analysis of the basic blocks, each basic block is marked as either a leader or a follower. Each Runnable has exactly one leader or entry point. All followers have exactly one leader. A leader and its followers make up a respective Runnable. During analysis of basic building blocks, leaders are determined by prescribed rules. A first rule is that the first block in a method is a leader. A second rule is that any block following a scheduler call is a leader. A third rule is that any method that has an entry point from greater than one Runnable is a leader.

After the one or more blocking methods are segmented into the respective plurality of non-blocking Runnables, an operation 115 is performed for configuring the plurality of non-blocking Runnables as event-based object code. Configuring the plurality of non-blocking Runnables as event-based object code preferably includes instrumenting the object code of each blocking method to schedule a jump to the first associated Runnable. Continuations are used for interconnecting adjacent Runnables. Continuations provide two elements of information used in configuring the plurality of Runnables. Continuations provide a pointer to the next instruction that should be executed by a thread the next time it runs and provide context information to be used by the thread the next time it runs. Examples of such context information include, but are not limited to, variable values and the method stack of the thread. Thus, continuations are leveraged to facilitate transformations by providing the mechanism to switch between threads without losing information about their state of execution.

The Vera ASIC simulation language is an example of a multi-threaded process-oriented simulation environment in which such multi-threaded process-oriented object code is developed. Conversion of such source code to the equivalent Java generally exhibits unacceptable thread overheads that adversely affect simulation performance. Transformation functionality in accordance with the present invention is capable of analyzing Java Bytecode and automatically transforms the multi-threaded simulation model to an efficient event based model for large gains in simulation performance, with no impact to the developer.

With multi-threaded, process-oriented object code, the process of switching between threads includes a Context switch. During a Context switch, the threading library swaps out the CPU state of the currently running thread and swaps in the CPU state of the next thread to be run. These Context switches generally have a significant overhead, especially when the threads themselves are not doing a lot of instruction processing between switches. Additionally, many modern operating systems (including Windows and Linux) have kernel based thread implementations that cause thread suspension and wake events to also incur the overhead of trapping into the kernel to make the call. Event-based object code eliminates these Context switches because it is inherently single-threaded, thus offering reduced overhead.

### EXAMPLE

### Transformation From Multi-Threaded Process Based object Code to Event-Based Object Code

Below is a multi-threaded, process-oriented object code consisting of two threads that include an operation split.

function main( )

{
// fork off two threads, which call m1( ) and
m2( ) respectively
fork
{

m1( );

}
{

m2( );

}

}
function m1( )
{
m1_loop:

| print(“m1 before yield”); | |
|---|---|
| yield( ); | // yield control to m2 |

print(“m1 after yield”);
goto m1_loop;

}
function m2( )
{
m2_loop:

| print(“m2 before yield”); | |
|---|---|
| yield( ); | // yield control to m1 |

print(“m2 after yield”);
goto m2_loop;

}

Assuming the thread calling m1( ) executes first, the output of this program looks like:

m1 before yield;
m2 before yield;
m1 after yield;
m1 before yield;
m2 after yield;
m2 before yield; and
m1 after yield.

However, because m1( ) and m2( ) are blocking threads (i.e. each yield to another thread), m1( ) and m2( ) are segmented into respective Runnables Segmentation is performed in accordance with the “leader rules” disclosed above. Segmentation produces four Runnables from m1( ) and m2( ):

Runnable 1

m1_part1:

m1_loop:
print(“m1 before yield”);
yield( );

Runnable 2

m1_part2:

print(“m1 after yield”);
goto m1_loop;

Runnable 3

m2_part1:

m2_loop:
print(“m2 before yield”);
yield( );

Runnable 4

m2_part2:

print(“m2 after yield”);
goto m2_loop;

Converted to event-based object code, the scheduler facilitating execution of these Runnables behaves as follows:
1) run m1_part1 until the thread yields
2) run m2_part1 until the thread yields
3) run m1_part2 until the thread yields
4) run m2_part2 until the thread yields

It should be noted that m1_part2 is going to schedule m1_part1 to run due to the ‘goto’ statement. Only after m1_part1 yields will m2_part2 get to run. This is observable in the output by the back-to-back “m1 . . . ” lines in the output.

All Runnables of a given method have a reference to a common, method-specific Context class. This class is responsible for (among other things) maintaining state between Runnable calls. For instance, if a local variable were used in both m1_part1 and m1_part2, the value of that variable would need to be saved in between the calls. Thus, just before m1_part1 yields, it needs to write all of the local variables it changed to the Context object. Likewise, when m1_part2 starts executing, the first thing it does is load all the local variables it uses from the Context object. This creates the illusion that nothing happened in between the last instruction of m1_part1 and m1_part2.

The present invention provides for a number of associated functionalities that are not addressed by prior art transformation approach. Examples of such functionalities include, but are not limited to, dealing with method return values by returning them through thread-specific areas, dealing with access privileges and Runnable inner classes by creating static access methods in the appropriate classes, handling exceptions, handling abstract methods by analyzing each implementation referenced in the scope of the analysis and handling method-local variables and method arguments by preserving such variables and arguments across Runnables that were part of the same method and writing back any values that were changed by the current Runnable before blocking. Providing for such functionalities enhances implementation of process-oriented to event-based transformation in that it provided for a comprehensive transformation implementation capable of handling large, complex programs such as, for example, Java simulations. As such, these functionalities further distinguish transformation functionality in accordance with the present invention over prior approaches

Access privileges are an important aspect to providing a comprehensive transformation implementation. The following example depicts an approach in accordance with the present invention for addressing access privileges.

### EXAMPLE

### Private Modifier for Controlling Access Privileges

Java provides a mechanism for limiting the access to variables declared in a class. One component of this mechanism is a private modifier. The functionalities of other such modifiers are similar.

class Foo
{

private int i;
public void ok_access( )
{

| Foo f = new Foo( ); | |
|---|---|
| f.i = f.i + 1; | // this is ok. Foo can access its variable, i. |

Scheduler.yield( );

}

}
class Bar
{

public void bad_access( )
{

| Foo f = new Foo( ); | |
|---|---|
| f.i = f.i + 1; | // ILLEGAL!! f.i can only be accessed in the |
| Foo class | |

}

}

Were a Runnable from class Foo created, this would actually create a new Runnable class and copy the appropriate code from Foo. Such an approach to creating a Runnable can be problematic when the copied code refers to private variables. This is because the new class doesn't have the proper access privileges to access the private data.

In accordance with the present invention, synthetic methods in the original class are created that provide the ability to set/get a value. In essence this approach entails creating static access methods in the appropriate classes. This is identical to the method used by Java compilers to implement access to private members from inner classes. It should be noted that these synthetic methods are only in the compiled class files. There is no source code for them.

For instance, the following methods might be appended to Foo and called by the public static int getI(Foo f).

{

return f.i;

}
public static void setI(Foo f, int i)
{

f.i = i;

}

In the created Runnable, the transformer would convert code as follows.

f.i=f.i+1; //ILLEGAL for the Runnable, since it doesn't have access to f.i would be converted to

Foo.setI(f, Foo.getI(f)+1);//OK since static accessors are public

Due to the common occurrence of exceptions, handling of exceptions is another important aspect to providing a comprehensive transformation implementation. In accordance with at least one embodiment of the present invention, when a method throws an exception, the scheduler has to determine if this method or a method further up the stack handles the exception. The scheduler does this by using the Context object (discussed above) for each method. This Context object is responsible for knowing which exceptions are being caught by this method at a given point of execution. Thus, when a method throws an exception, the scheduler goes up the program stack, looking for a context that handles the thrown exception. If it finds one, it runs the Runnable associated with that exception handler. Otherwise, it returns an error.

Addressing method return values is yet another important aspect to providing a comprehensive transformation implementation. Because the original bodies of methods are modified to set-up the call to the first Runnable and then return, they do not have a valid return value. In accordance with the present invention, method return values are addressed by saving return values in a thread-specific area by the last Runnable in a method. The Runnable that it jumps to (in the caller) can access that return value if it so desires.

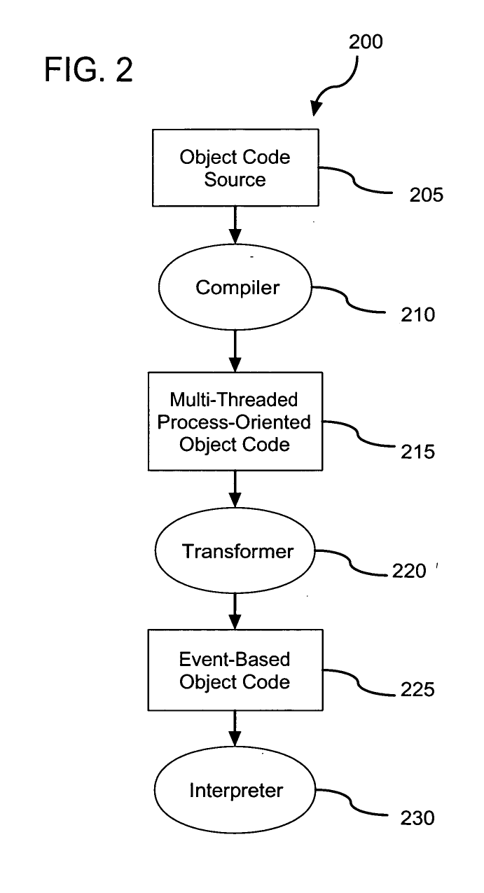

FIG. 2 depicts an embodiment of an object code process flow (generally referred to as the process flow 200) in accordance with the present invention. The process flow 200 includes an object code source 205 through which a developer creates an object code program. The object code program is provided to a compiler 210, which generates multi-threaded, process-oriented object code 215 corresponding to the object code program. From a developer standpoint, developing simulations represented by multi-threaded process-oriented object code is desirable due to the fact that multi-threaded process-oriented object code is intuitive, is better matches a particular domain object model, and is easier to develop and maintain. Thus, developing simulations represented by multi-threaded process-oriented object code is preferable.

The multi-threaded, process-oriented object code 215 is provided to a transformer 220 that facilitates transformation functionality in accordance with the present invention (i.e., as described above). The result of such transformation is event-based object code 225 that is configured for providing output equivalent to that resulting from execution of the multi-threaded process-oriented object code. However, upon being executed by an interpreter 230, the event-based object code 225 provides for increased execution performance (e.g., accelerated interpretation). The increased execution performance stems from the event-based object code exhibiting reduced overhead associated with thread Context switches. Accordingly, transformation functionality in accordance with the present invention provides developers with the ability to program in multi-threaded process-oriented object code while gaining the execution efficiency of equivalent event-based object code.

A skilled person will recognize that transformation functionality in accordance with the present invention is especially useful for, although not limited to, ASIC simulation. Specifically, it is useful in that it solves the problem of unification of multi-threaded simulation environments with event-based such as, for example, Verilog simulators.

For simulation in general, the majority of simulation languages, libraries, and development environments are process-oriented in nature, meaning that the structure exposed to the developer is either multi-threaded or multi-process. The majority of these environments end up with severe performance penalties as the number of threads increase. Accordingly, automated transformation to an event-based simulation in accordance with the present invention is potentially applicable across the simulation industry (e.g., hardware simulation) as a whole.

There are several commercially available simulation environments: Synopsys Vera, Verisity Specman, Cadence Testbuilder and SystemC SCV. In each of these cases, the program structure exposed to the simulation developer is a process-oriented simulation to ease development. These simulation environments integrate with underlying Verilog simulators. Verilog is inherently an event-based language and simulation environment. Each of the major EDA vendors have strategies of more closely integrating the simulation environments with the underlying Verilog simulator. Additionally, in each of these cases, the EDA vendors are attempting to integrate a process-oriented simulation environment with an underlying event-based simulator. Transformation functionality in accordance with the present invention provides a means for removing the threads from the process-oriented simulation and turning them into events to be uniformly processed by the underlying simulator kernel. Through such transformation overhead is dramatically reduced and simulation performance is correspondingly increased.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical and electrical changes may be made without departing from the spirit or scope of the invention. For example, functional blocks shown in the figures could,be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method, comprising:
analyzing multi-threaded process-oriented object code; and
transforming said multi-threaded process-oriented object code to event-based object code that provides equivalent output as said multi-threaded process-oriented object code, wherein said transforming is performed automatically in response to said analyzing and wherein said transforming includes creating continuation functionality between adjacent Runnable methods of said event-based object code.

2. The method of claim 1 wherein:
said analyzing object code includes determining a potentially blocking method and analyzing control flow of the potentially blocking method; and
said transforming multi-threaded process-oriented object code includes configuring said event-based object code to schedule a jump to a first one of a plurality of non-blocking Runnable methods of the event-based object code.

3. The method of claim 2 wherein said analyzing control flow of the potentially blocking method includes:
segmenting the potentially blocking method into the plurality of non-blocking Runnable methods; and
associating each one of said non-blocking Runnable methods with a respective one of a plurality of available exception handlers.

4. The method of claim 2 wherein the potentially blocking method is an abstract method and analysis is performed on all methods implementing the abstract method to discover if the abstract method should be marked as a blocking method.

5. The method of claim 1 wherein said continuation functionality includes:
providing direction to a next instruction that a thread follows during a subsequent instance of execution; and
providing context information accessible by the thread during the subsequent instance of execution.

6. The method of claim 1 wherein:
said analyzing object code includes identifying an instance of an access privilege; and
said transforming multi-threaded process-oriented object code includes creating a static access method in an object class corresponding to the access privilege.

7. The method of claim 1 wherein:
said analyzing object code includes identifying an instance of a method return value; and
said transforming multi-threaded process-oriented object code includes creating a thread-specific area configured for having return values stored therein, configuring said event-based simulation model object code to save instances of said return values in the thread specific area and enabling Runnable methods of the event-based simulation object code to access said return values from the thread-specific area.

8. The method of claim 1 wherein said transforming multi-threaded process-oriented object code includes configuring said event-based object code to:
recognize an instance of an exception while executing a Runnable method;
save a context state associated with the exception to a corresponding context object; and
query the context object of the Runnable method for determining existence of a handler capable of addressing the exception.

9. The method of claim 8 wherein said transforming multi-threaded process-oriented object code includes configuring said event-based object code to:
schedule an identified handler to run in response to said handler being determined to exist; and
otherwise implementing an error condition.

10. The method of claim 1 wherein:
said analyzing object code includes determining a potentially blocking method and analyzing control flow of the potentially blocking method;
said analyzing control flow of the potentially blocking method includes segmenting the potentially blocking method into the plurality of non-blocking Runnable methods and associating each one of said non-blocking Runnable methods with a respective one of a plurality of available exception handlers;
said transforming multi-threaded process-oriented object code includes configuring said event-based object code to schedule a jump to a first one of a plurality of non-blocking Runnable methods of the event-based object code;
said continuation functionality includes providing direction to a next instruction that a thread follows during a subsequent instance of execution and providing context information accessible by the thread during the subsequent instance of execution; and
said transforming multi-threaded process-oriented object code includes configuring said event-based object code to recognize an instance of an exception while executing a Runnable method, save a context state associated with the exception to a corresponding context object and query the context object of the Runnable method for determining existence of a handler capable of addressing the exception.

11. A method, comprising:
determining a potentially blocking method in multi-threaded process-oriented object code representing a simulation model;
segmenting the potentially blocking method into a plurality of non-blocking Runnable methods; and
configuring event-based object code representing a simulation model equivalent to the simulation model represented by said multi-threaded process-oriented object code for scheduling a jump to a first one of a plurality of non-blocking Runnable methods of the simulation model represented by the event-based object code.

12. The method of claim 11, further comprising:
associating each one of said non-blocking Runnable methods with a respective one of a plurality of available exception handlers.

13. The method of claim 11 wherein determining the potentially blocking method includes any one of determining whether a method invokes a call asking to yield control of a current thread, determining whether the potentially blocking method invokes a call asking to wait on a particular event and determining whether the method invokes a different method that at least one of invokes a call asking to yield control of a current thread and invokes a call asking to wait on a particular event.

14. The method of claim 11, further comprising:
configuring said event-based object code to provide direction to a next instruction that a thread follows during a subsequent instance of execution and providing context information accessible by the thread during the subsequent instance of execution.

15. The method of claim 11, further comprising at least one of:
identifying an instance of an access privilege and creating a static access method in an object class corresponding to the access privilege;
identifying an instance of a method return value, creating a thread-specific area configured for having return values stored therein, configuring said event-based object code to save instances of said return values in the thread specific area and enabling Runnable methods of said event-based object code to access said return values from the thread-specific area; and
configuring said event-based object code to recognize an instance of an exception while executing a Runnable method, save a context state associated with the exception to a corresponding context object and query the context object of the Runnable method for determining existence of a handler capable of addressing the exception.

16. The method of claim 11, further comprising:
associating each one of said non-blocking Runnable methods with a respective one of a plurality of available exception handlers;
configuring said event-based object code to provide direction to a next instruction that a thread follows during a subsequent instance of execution and providing context information accessible by the thread during the subsequent instance of execution;
identifying an instance of an access privilege and creating a static access method in an object class corresponding to the access privilege;
identifying an instance of a method return value, creating a thread-specific area configured for having return values stored therein, configuring said event-based object code to save instances of said return values in the thread specific area and enabling Runnable methods of said event-based object code to access said return values from the thread-specific area; and
configuring said event based object code to recognize an instance of an exception while executing a Runnable method, save a context state associated with the exception to a corresponding context object and query the context object of the Runnable method for determining existence of a handler capable of addressing the exception.

17. The method of claim 16 wherein determining the potentially blocking method includes any one of determining whether a method invokes a call asking to yield control of a current thread, determining whether the potentially blocking method invokes a call asking to wait on a particular event and determining whether the method invokes a different method that at least one of invokes a call asking to yield control of a current thread and invokes a call asking to wait on a particular event.

18. The method of claim 17 wherein the potentially blocking method is an abstract method and analysis is performed on all methods implementing the abstract method to discover if the abstract method should be marked as a blocking method.

19. A method, comprising:
analyzing multi-threaded process-oriented Java Bytecode representing a simulation model; and
transforming said multi-threaded process-oriented Java Bytecode to event-based Java Bytecode representing a simulation model equivalent to the simulation model represented by said multi-threaded process-oriented Java Bytecode, wherein said transforming is performed automatically in response to said analyzing and wherein said transforming includes creating continuation functionality between adjacent threads of execution.

20. The method of claim 19 wherein said continuation functionality includes:
providing direction to a next instruction that a thread follows during a subsequent instance of execution; and
providing context information accessible by the thread during the subsequent instance of execution.

21. The method of claim 20 wherein said transforming multi-threaded process-oriented Java Bytecode includes configuring said event-based Java Bytecode to:
recognize an instance of an exception while executing a Runnable method;
save a context state associated with the exception to a corresponding context object; and
query the context object of the Runnable method for determining existence of a handler capable of addressing the exception.

22. The method of claim 21 wherein:
said analyzing Java Bytecode includes determining a potentially blocking method and analyzing control flow of the potentially blocking method; and
said transforming Java Bytecode includes configuring said event-based Java Bytecode to schedule a jump to a first one of a plurality of non-blocking Runnable methods of the simulation represented by said event-based object code.

23. The method of claim 22 wherein said analyzing control flow of the potentially blocking method includes:
segmenting the potentially blocking method into the plurality of non-blocking Runnable methods; and
associating each one of said non-blocking Runnable methods with a respective one of a plurality of available exception handlers.

24. The method of claim 22 wherein the potentially blocking method is an abstract method and analysis is performed on all methods implementing said abstract method to discover if it should be marked as a blocking method.
